(19) United States
(12) Patent Application Publication
(10) Pub. No.: US 2007/0187858 A1
(43) Pub. Date: Aug. 16, 2007

(54) METHOD FOR PRODUCING OPEN-PORED COMPONENTS MADE OF METAL, PLASTIC, OR CERAMIC

(75) Inventor: Bernd Kuhs, Lorrach (DE)

Correspondence Address: BLAKELY SOKOLOFF TAYLOR & ZAFMAN, 1279 OAKMEAD PARKWAY, SUNNYVALE, CA, 94085-4040, US

(73) Assignees: Bernd Kuhs, Lorrach (DE); Laempe & Mossner GmbH, Schopfheim (DE); Kurtz GmbH, Kreuzwertheim (DE)

(21) Appl. No.: 11/623,683

(22) Filed: Jan. 16, 2007

(30) Foreign Application Priority Data
Jan. 16, 2006 (DE) 10 2006 002 227.0

(51) Int. Cl. B29C 65/00

(52) U.S. Cl. 264/41

(57) ABSTRACT

A method is described, according to which open-pored components may be produced having a defined pore size, a defined external skin thickness, and a low density. A fine carrier material, is shaped with the aid of a binder into balls (1) which are as uniform as possible according to a shaping method, the prefinished balls (1) are wetted or coated using the same or also a different binding medium and poured in this way into the desired external mold and caused to stick and/or form binder bridges (2) at the contact points by a curing method. The balls (1) connected to one another are removed from their mold and placed into the desired mold, after which the cavities (3) between the balls (1) are filled with metal, plastic, or ceramic. After solidification, all of the ball material may be removed and/or washed out by vibration and/or by washing using water.

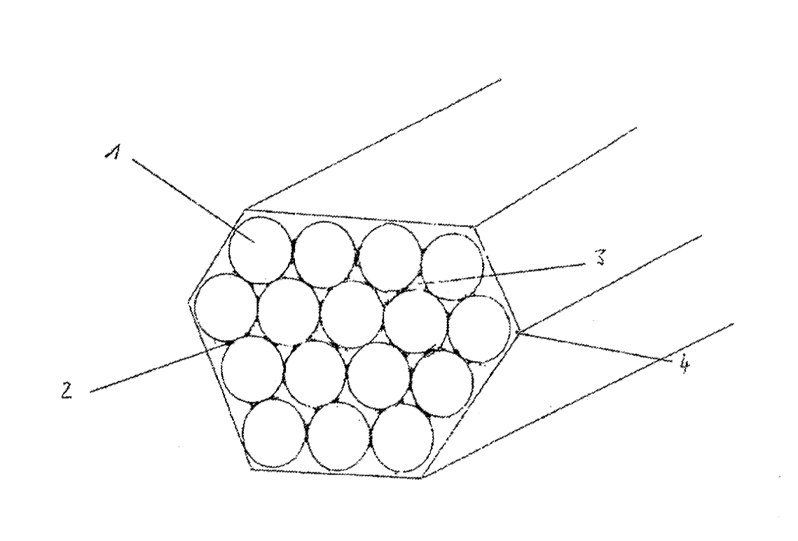

### CROSS-REFERENCE TO RELATED APPLICATIONS

The present patent application claims priority from German Patent Application No. 10 2006 002 227.0, filed on Jan. 16, 2006.

### BACKGROUND OF THE INVENTION

The present invention relates to a method for producing open-pored components made of metal, plastic, or ceramic.

For some time, attempts have been made to provide metals with suitable propellants, such as gases, in order to foam them in the liquid state, by which a lower density and a higher strength of components produced therefrom are to be achieved simultaneously. However, these known methods have the disadvantage that the (gas) bubbles introduced arise in a very uncontrolled way and reach differing sizes which are not clearly defined. In addition, the bubbles penetrate up to the surface of the components and do not allow a defined external skin thickness to result, which would be necessary for a calculable, static function.

### SUMMARY OF THE INVENTION

The object of the present invention is to indicate a method which allows the production of open-pored components from metal, plastic, or ceramic having a defined pore size, having a defined external skin thickness if needed, and having a low density.

This is achieved by a method having the features according to Claim 1.

The subclaims relate to advisable refinements of the present invention.

### BRIEF DESCRIPTION OF THE DRAWINGS

The invention is further described with reference to the drawing, which is a perspective view of an open-pored component according to an embodiment of the invention.

### DESCRIPTION OF THE INVENTION

According to the present invention, balls 1 are first produced in the desired pore size. These balls 1 may having diameter of 5 mm, for example, and are produced by admixing a suitable foundry sand or a quartz flour with a sand binder known in the foundry process, for example, and shaping it into balls 1 which are as uniform as possible through a suitable shaping method, such as granulation, pelleting, or shooting.

The cured balls 1 are now in turn provided with a binder and/or coated and then placed in the desired mold. The balls 1 are bound to one another by a curing method corresponding to the binder, this may be a treatment using hot air, using carbon dioxide, or using an amine, or also solely a heat treatment by microwaves, for example. Preferably, this procedure is performed by drying or, depending on the type of the binder, by passing through a reactive gas, or such as an amine or carbon dioxide, or by curing using microwaves or by storage in a drying furnace. Binder bridges 2 arise between the individual balls 1, only where the balls 1 are in contact (see the appended drawing).

The binders must either be selected in such a way that they decompose due to the heat effect of the hot metal, plastic, or the hot ceramic, or they much be water-soluble, so that after the casting using a metal, plastic or a ceramic compound, they may be removed from the component again. Many different foundry binders based on organic or also inorganic compounds are available for this purpose.

The ball formation may now in turn be placed in a mold, such as a permanent mold. The later thickness of the external skin of a component may be determined via the distance between the ball formation and the permanent mold wall. The cavities 3 between balls 1 and the intermediate space 4 which has formed between the ball formation and the external mold, such as the permanent mold, are now filled with the metal or plastic or a ceramic compound by a suitable casting method. Preferably, the entire ball formation is previously heated in a furnace in the event of filling with metal in order to ensure the ability of the metal to flow into all fine intermediate spaces. For example, a typical low-pressure casting technique suggests itself for metals. In order to prevent penetration of the filling medium into the interior of the balls 1, they may also be previously impregnated with a suitable agent.

After the hardening of the molten metal, the plastic, or the ceramic compound, all ball material may be removed from the component by vibration or by floating using water. For this purpose, at least one side of the component is produced without external skin, or the external skin is subsequently reopened at a suitable point, e.g., drilled open, so that all ball material may be removed completely without residue, since all cavities resulting via the binder bridges 2 between the balls 1 are connected to one another. The larger the binder bridges 2 have previously been implemented, i.e., the more binder has previously been used for the connection of the balls 1, the larger the passages between the spherical cavities are afterward.

In this way, even large components may also be produced having defined shaping, having a clearly defined pore size and precisely defined external skin thickness, which was not possible using methods described until now.

In a special embodiment of the present invention, fibers are admixed to the molten metal, the plastic, or the ceramic compound, which then automatically orient themselves in the ball intermediate spaces during the filling procedure along the channels formed between the balls 1 by the intermediate spaces and thus may also cause a significant increase of the strength. These fibers may be carbon, glass, mineral, or artificial fibers, which must have their length selected in such a way that they may orient themselves in the intermediate spaces between the balls. Components produced in this way may be used in all cases where light components must nonetheless have a very high stability and strength. This is especially the case in vehicle and aircraft construction and in space travel. However, applications in construction, mechanical engineering, and the furniture industry are also conceivable.

A special application results in the even of use in heat exchangers, cooling assemblies, and as a replacement of cooling ribs of any type. Especially components produced according to the method described above having a material having good thermal conductivity, such as aluminum and copper alloys, are outstandingly suitable for use in cooling assemblies, for example, because of their good air permeability and large surface. Still a further constructive advantage results for this purpose if, for example, cooling coils for transporting a coolant are already placed directly between the balls 1 before casting with the metal and before the compaction of the balls 1 with one another. In this way, in one work step, the cooling coil is produced and/or the cooling or heating popes are fused with the metal. Through this possibility of production, the cooling or heating popes do not have to be subsequently pushed through a framework and fixed, as is otherwise normal in typical cooling assemblies or heat exchangers. In addition, many and significantly longer cooling and heating pipes may be laid in the ball formations as desired as spirals or as a clew, from which a much better capability of heat exchange results.

In a special production variation, the above-mentioned balls 1 are introduced into a mold and bonded via cured binder bridges 2 and the cavities 3 are then subsequently not completely filled with a heat conductive material, preferably an aluminum alloy, but rather the ball formation and its cavities 3 are only wetted. In this way, after the ball material is removed, two continuous cavities which are spatially separated from one another result, one continuous cavity for the cooling or heating medium and a second continuous cavity, separated therefrom and nested therewith, for the medium to be cooled or heated. It is not necessary to install any type of cooling or heating pipes to produce a heat exchanger of this type. The balls 1 are preferably produced in this case from a fine quartz flour and a heat resistant binder; an inorganic material is preferably used as a binder both for the production and also for the binding of the balls 1 to one another, as is known in foundry sand binders, such as a silicate, magnesium sulfate, and/or a phosphate. This compacted ball formation is then to be brought to at least the same temperature as the metal to be poured in. In this way, it is ensured that after a first complete filling of the cavities 3, the metal has not yet hardened and the excess metal may drain off again from the cavities 3. In this way, practically all surfaces are coated with metal, and a continuous cavity between the balls 1 still results after the metal drains off. After the hardening of the metal, all of the ball mold material is washed out, by which the second, continuous cavity is released, which is completely separated from the first cavity produced. Connections for both cavities or chambers may also be taken into consideration during the molding and cast at the same time during the casting procedure. If leaks result between the two cavities or chambers, these may be closed by introducing a sealing lacquer into one or also both cavities or chambers, for example.

What is claimed:

1. A method for producing light components made of metal, metal alloys, plastic or ceramic of various geometries, characterized in that a fine carrier material, preferably quartz sand or quartz flour, is shaped into balls (1) which are as uniform as possible with the aid of the binder according to a shaping method, preferably by granulation, pelleting or another shaping method, the prefinished balls (1) are wetted or coated with the same or also a different binding medium and placed in this way in the desired, external mold and caused to stick and/or to form binder bridges (2) at the contact points by a curing method, the balls (1), which are connected to one another via binder bridges (2) or by fusing, are removed from their mold and placed in the desired external mold or permanent mold, subsequently the cavities (3) between the balls (1) are filled, by the methods known in foundry processes, preferably a low-pressure method, with liquid metal or a metal alloy or liquid plastic or a ceramic compound, and after the solidification of the metal or the compound, all of the ball material is removed and/or washed out of the solidified metal or the solidified compound by vibration and/or by washing with water.

2. The method according to claim 1, characterized in that the balls are formed by adding water to the carrier material.

3. The method according to claim 1, characterized in that the binder is of an organic nature, preferably a resin which cures due to amine gas.

4. The method according to claim 1, characterized in that the binder is a water-soluble, inorganic binder based on magnesium sulfate. phosphate, or silicate or a mixture thereof.

5. The method according the claim 1, characterized in that the material filling up the cavity is an artificial resin, such as a polyurethane, epoxide, polyester, acrylate, or also a thermoplastic, which may be cured by cooling and/or via a reaction with a corresponding curing agent.

6. The method according to claim 1, characterized in that the filling of the cavities (3) is performed with the aid of an injection molding machine known per se and at relatively high pressure.

7. The method according to claim 1, characterized in that the material filling up the cavity comprises a ceramic compound or a ceramic slip otherwise used for producing high-quality ceramics, which may be cured by drying and/or by reaction with a corresponding curing agent and/or by firing in a kiln.

8. The method according to claim 7, characterized in that the resulting parts are subsequently fired once again at higher temperature after the removal of the ball material.

9. The method according to claim 1, characterized in that the material used for producing the balls (1) is a quartz flour.

10. The method according to claim 1, characterized in that the material used for producing the balls (1) is an inorganic flour or sand comprises mixtures of, for example, quartz feldspar, aluminum oxide, chamottes, olivine, chromium ore, clays, kaolins, fluorite, silicates, bentonites, etc., or also these individual substances.

11. The method according to claim 1, characterized in that the material used for producing the balls (1) is a salt, such as NaCl, KC1, K₂SO₄, Mg₂SO₄.

12. The method according to claim 1, characterized in that the material used for producing the balls (1) is a metal powder.

13. The method according to claim 1, characterized in that the material used for producing the balls (1) is an organic material, such as a water-soluble polyvinyl acetate or a PVP or an acrylate or a plastic granulate or a flour made of, for example, polyethylene, polypropylene, Teflon powder, etc.

14. The method according to claim 1, characterized in that the binder used for producing the balls (1) and/or the binder used for binding the balls (1) to one another solely comprises water.

15. The method according to claim 1, characterized in that the binder used for producing the balls (1) and/or the binder used for binding the balls (1) to one another comprises water and a salt dissolved in water.

16. The method according to claim 1, characterized in that the binder used for producing the balls (1) and/or the binder used for binding the balls (1) to one another comprises magnesium sulfate.

17. The method according to claim 1, characterized in that the binder used for producing the balls (1) and/or the binder used for binding the balls (1) to one another comprises a silicate, preferably sodium silicate.

18. The method according to claim 1, characterized in that the binder used for producing the balls (1) and/or the binder used for binding the balls (1) to one another comprises a phosphate.

19. The method according to claim 1, characterized in that the binder used for producing the balls (1) and/or the binder used for binding the balls (1) to one another comprises a binder typically used in foundry processes for producing molds and cores.

20. The method according to claim 1, characterized in that the balls (1) have diameters of 0.2 mm to 30 cm.

21. The method according to claim 1, characterized in that the balls (1) have diameters preferably of 4-8 mm.

22. The method according to claim 1, characterized in that the balls (1) are produced according to a method known for shaping.

23. The method according to claim 1, characterized in that the balls (1) are produced by a granulation method, preferably on a pelleting disk or a spray granulator.

24. The method according to claim 1, characterized in that the balls (1) are produced by introducing the molding material into two half shells and by compression or by shooting in using compressed air.

25. The method according to claim 1, characterized in that in the event of an intended use of the component as a part of a heat exchanger or a cooling assembly, the cooling or heating coils are introduced directly into the ball formation, before the balls (1) are bonded to one another by curing processes.

26. The method according to claim 1, characterized in that the balls (1) are heated before the cavity (3) between the balls (1) is filled with a metal or a metal alloy.

27. The method according to claim 1, characterized in that the balls (1) are heated up to 800° C. before the cavity (3) between the balls (1) is filled with an aluminum alloy.

28. The method according to claim 1, characterized in that the balls (1) are heated up to 1600° C. before the cavity (3) between the balls (1) is filled with a cast-iron alloy.

29. The method according to claim 1, characterized in that the balls (1) are only wetted using a liquid metal or a plastic or a ceramic slip and the excess material is removed from the cavities (3) again.

30. The method according to claim 1, characterized in that two separate, continuous cavities are formed after the removal of the ball material.

31. The method according to claim 1, characterized in that connecting pieces required for the cavities are already taken into consideration during the shaping and are cast at the same time as the cavities are filled.

32. The method according to claim 30, characterized in that possible leaks between the two continuous cavities or chambers are closed using a sealing medium.

33. The method according to claim 1, characterized in that the liquid metal, the liquid metal alloy, the liquid plastic, or the ceramic compound contain fibers, whose length is selected in such a way that they orient along the channels in the ball intermediate spaces (3) formed by the intermediate spaces (3) during the filling procedure.

34. The method according to claim 33, characterized in that the fibers have a length of 3 to 4 mm.

35. The method according to claim 33, characterized in that the fibers are carbon, glass, mineral, or artificial fibers.
